(19) United States
(12) Patent Application Publication
(10) Pub. No.: US 2023/0341245 A1
(43) Pub. Date: Oct. 26, 2023

(54) OPTICAL FREQUENCY DOMAIN REFLECTOMETRY APPARATUS AND METHOD

(71) Applicant: NIPPON TELEGRAPH AND TELEPHONE CORPORATION, Tokyo (JP)

(72) Inventors: Tatsuya OKAMOTO, Musashino-shi, Tokyo (JP); Daisuke IIDA, Musashino-shi, Tokyo (JP); Hiroyuki OSHIDA, Musashino-shi, Tokyo (JP)

(73) Assignee: NIPPON TELEGRAPH AND TELEPHONE CORPORATION, Tokyo (JP)

(21) Appl. No.: 18/025,697

(22) PCT Filed: Sep. 15, 2020
(86) PCT No.: PCT/JP2020/034817

§ 371 Date: Mar. 10, 2023

(51) Int. Cl. G01D 5/353

(52) U.S. Cl. CPC G01D 5/35358

(57) ABSTRACT

The present disclosure aims to enable measurement of a long distance exceeding 1 km with a spatial resolution of 100 μm or lower, and diagnosis of health of an optical device installed at a long distance.

An apparatus according to the present disclosure is an optical frequency domain reflectivity measuring apparatus that includes: a local light delay fiber that delays local light; an optical 90-degree hybrid that receives an input of the local light delayed by the local light delay fiber and backscattered light from the measurement target, causes the local light and the backscattered light to interfere with each other, and generates an in-phase component and an orthogonal component of a beat signal generated by the interference; and a balance photodetector that detects the in-phase component and the orthogonal component of the beat signal. In the apparatus, an optical frequency response of the measurement target is measured with respect to a relative distance based on the local light delay fiber.

### TECHNICAL FIELD

The present disclosure relates to optical frequency domain reflectometry.

### BACKGROUND ART

In optical frequency domain reflectometry (OFDR), the optical frequency response of the measurement target is measured with respect to an absolute distance z, and a Fourier transform thereof is calculated, to obtain a backscattered waveform (see Non Patent Literature 1, for example). At this stage, the optical frequency response of the measurement target is sampled at equal optical frequency intervals (FSR of a reference interferometer) in accordance with a clock signal obtained by the reference interferometer.

According to the sampling theorem, the measurable distance in OFDR is determined by the fiber length of the reference interferometer. Furthermore, if the fiber length of the reference interferometer is made longer than the coherence length of the light source, the quality of the clock deteriorates, the beat signal cannot be sampled at equal intervals, and the optical frequency response cannot be measured correctly (the backscattered light waveform cannot be analyzed). Therefore, the existing measurement performance is expressed as a measurement distance of 10 m and a spatial resolution of 100 μm or lower (see Non Patent Literature 2, for example).

### CITATION LIST

### Non Patent Literature

Non Patent Literature 1: U. Glombitza and E. Brinkmeyer, “Cohenret frequency-domain reflectometry for characterization of single-mode integrated-optical waveguides”, IEEE JLT, vol. 11, no. 8, pp. 1377-1384, Aug. 1993.
Non Patent Literature 2: B. J. Soller et al., “High resolution optical frequency domain reflectometry for characterization of components and assemblies”, Opt. Exp., vol. 13, no. 2, pp. 666-674, Jan. 2005.

### SUMMARY OF INVENTION

### Technical Problem

The present disclosure aims to enable measurement of a long distance exceeding 1 km with a spatial resolution of 100 μm or lower, and diagnosis of health of an optical device installed at a long distance.

### Solution to Problem

An apparatus according to the present disclosure is

an optical frequency domain reflectivity measuring apparatus that includes:
a local light delay fiber that delays local light;
an optical 90-degree hybrid that receives an input of the local light delayed by the local light delay fiber and backscattered light from the measurement target, causes the local light and the backscattered light to interfere with each other, and generates an in-phase component and an orthogonal component of a beat signal generated by the interference; and
a balance photodetector that detects the in-phase component and the orthogonal component of the beat signal,
wherein
an optical frequency response of the measurement target is measured with respect to a relative distance based on the local light delay fiber.

A method according to the present disclosure is

a method implemented by an optical frequency domain reflectivity measuring apparatus,

the optical frequency domain reflectivity measuring apparatus includes:
a local light delay fiber that delays local light;
an optical 90-degree hybrid that receives an input of the local light delayed by the local light delay fiber and backscattered light from the measurement target, and outputs an in-phase component and an orthogonal component of a beat signal generated by interference between the local light and the backscattered light; and
a balance photodetector that detects the in-phase component and the orthogonal component of the beat signal,
wherein
an optical frequency response of the measurement target is measured with respect to a relative distance based on the local light delay fiber.

### Advantageous Effects of Invention

According to the present disclosure, it is possible to measure a long distance exceeding 1 km with a spatial resolution of 100 μm or lower, and diagnose health of an optical device installed at a long distance.

### BRIEF DESCRIPTION OF DRAWINGS

FIG. 1 illustrates an example configuration of a test system of the present disclosure.

FIG. 2 illustrates an example system configuration in a case where the beat frequency f_{beat} corresponding to the absolute distance z is observed.

FIG. 3 illustrates an example relationship between beat frequency and distance in the present disclosure.

FIG. 4 illustrates an example relationship between beat frequency and distance measured with the configuration illustrated in FIG. 2.

FIG. 5 illustrates an example of a spectrum to be measured with the configuration illustrated in FIG. 2.

FIG. 6 illustrates an example of a spectrum to be measured with the configuration of the present disclosure.

FIG. 7 illustrates an example of results of Fresnel reflection measurement at a point of 3 km.

### DESCRIPTION OF EMBODIMENTS

The following is a detailed description of embodiments of the present disclosure, with reference to the drawings. Note that the present disclosure is not limited to the embodiments described below. These embodiments are merely examples, and the present disclosure can be carried out in forms with various modifications and improvements based on the knowledge of those skilled in the art. Note that like components are denoted by like reference numerals in this specification and the drawings.

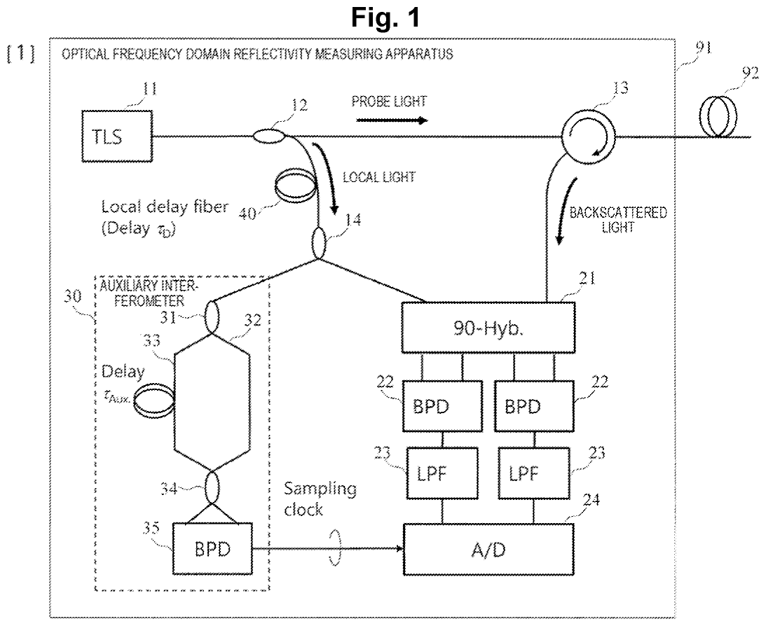

FIG. 1 illustrates an example configuration of a test system of the present disclosure. In the test system of the present disclosure, an optical frequency domain reflectivity measuring apparatus 91 is connected to a measurement target optical fiber 92. The optical frequency domain reflectivity measuring apparatus 91 includes a wavelength swept light source (TLS) 11, a coupler 12, a circulator 13, an optical 90-degree hybrid 21, balance photodetectors (BPDs) 22, low-pass filters (LPFs) 23, an A/D converter circuit 24, an auxiliary interferometer 30, and a local delay fiber 40.

The coupler 12 splits light from the TLS 11 into local light and probe light. A coupler 14 splits the local light from the coupler 12. One local light is input to the auxiliary interferometer 30, and the other local light is input to the 90-degree hybrid 21. The circulator 13 inputs the probe light to the measurement target optical fiber 92, and outputs backscattered light scattered by the measurement target optical fiber 92 to the 90-degree hybrid 21.

The 90-degree hybrid 21 causes the local light and the backscattered light to interfere with each other, and generates the in-phase component and the orthogonal component of the signal (a beat signal) generated by the interference.

The BPDs 22 detect the in-phase component and the orthogonal component of the beat signal, respectively.

The LPFs 23 transmit only the low-frequency components of the output signals from the BPDs 22, which are the beat signals of the local light and the backscattered light.

The A/D 124 converts the analog signals output from the LPFs 23 into digital signals, in accordance with a sampling clock from the auxiliary interferometer 30.

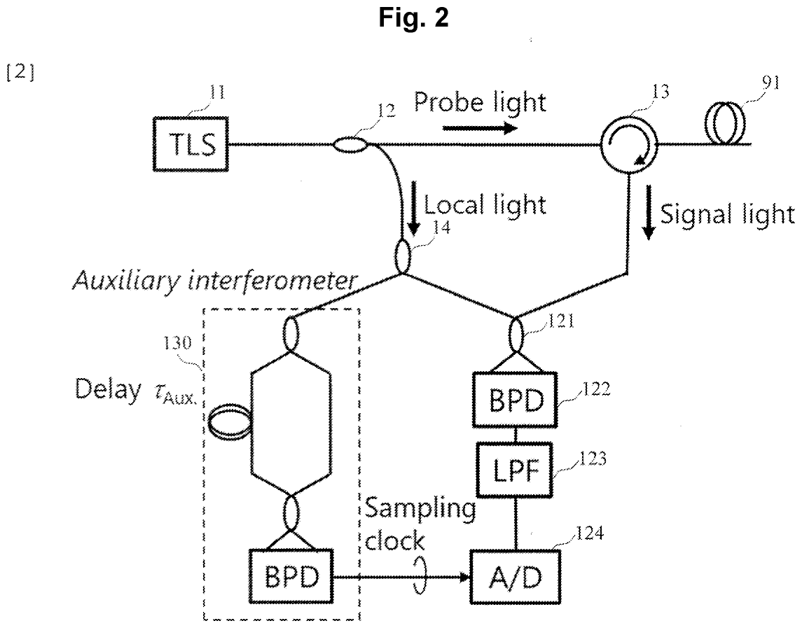

Referring now to FIG. 2, an example system configuration in a case where the beat frequency f_{beat} corresponding to the absolute distance z is observed is described. In the configuration illustrated in FIG. 2, the local delay fiber 40 and the optical 90-degree hybrid 21 are not included, and there is only one balance photodetector 122 and one LPF 123.

In the configuration illustrated in FIG. 2, a coupler 121 is provided in place of the 90-degree hybrid 21. In this case, a beat signal of local light and backscattered light is generated by the coupler 121, and is input to the BPD 122. Further, the A/D 124 converts the analog signal into a digital signal, in accordance with a sampling clock to which a delay τ_{AUX} is given by the auxiliary interferometer 130. In this case, the optical frequency response r^{˜}(ν) to be measured is expressed by the expression shown below (see Expression (5) of Non Patent Literature 1, for example).

### [Mathematical Expression 1]

r̅(ν)=∫r(τ)exp[−j2πν(t)τ]dτ (1)

Here, the parameters are as follows.

r(τ): reflection coefficient

ν: optical frequency

τ: the delay due to reciprocating propagation over distance z, and τ=2z/c

z: the distance to the measurement target in the longitudinal direction

c: the velocity of light propagating in the measurement target

Fourier transform of the optical frequency response r^{˜}(ν) results in a backscattered light waveform r(τ).

[Mathematical formula 2]

r(τ)=∫r(ν)exp[j2πτν]dv (2)

Further, the optical frequency response r^{˜}(ν) is sampled in the optical frequency domain. For example, in a case where the sampling period is 1/τ_{AUX}.=FSR, the maximum measurable delay (Nyquist frequency) is 1/(2*FSR)=τ_{AUX}./2. Therefore, the length of a reference interferometer 130 determines the length of the measurable absolute distance.

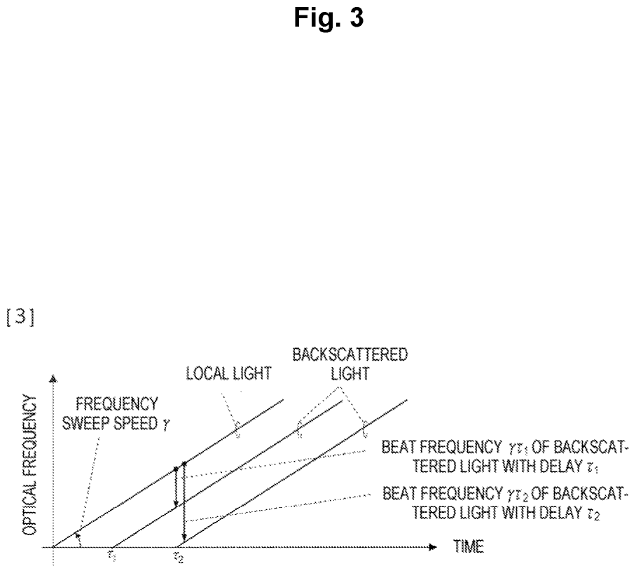

In the conventional system illustrated in FIG. 2, the delay amount of the local light is zero, and therefore, a beat frequency is assigned in accordance with the delay (absolute distance) of the backscattered light as illustrated in FIG. 3. Accordingly, in the configuration illustrated in FIG. 2, the 90-degree hybrid 21 is not necessary.

(Role of the Optical 90-Degree Hybrid 21)

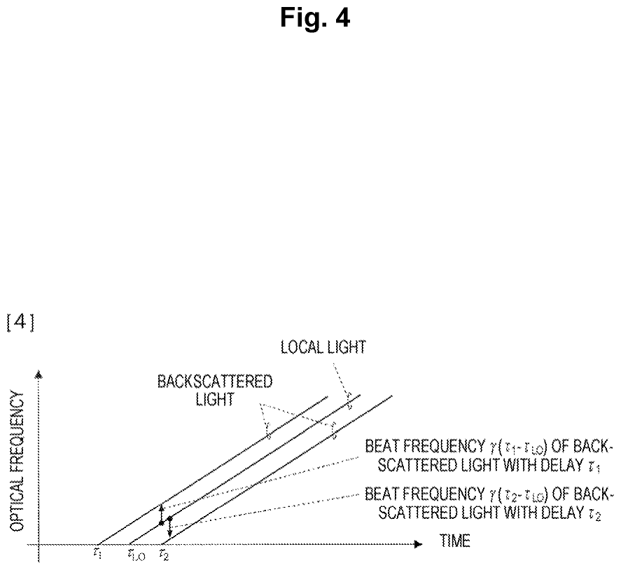

In the present disclosure, distance offsets are given to distances measured by the delay fiber 40 for the local light, and a measured distance is selected. At that time, light interferes with the backscattered light on the front side and the rear side of the delay amount of the local light, as illustrated in FIG. 4. Although beat frequencies are assigned in accordance with relative distances, two points having the same relative distance (two points on the front side and the rear side, with the delay amount of the local light being the point of symmetry) have the same beat frequency quantity. Reflected light having a distance shorter than the delay τ_{D} of the local light has a negative beat frequency, and reflected light having a longer distance has a positive beat frequency. Therefore, in the present disclosure, the optical 90-degree hybrid 21 and the BPDs 22 detect the in-phase component and the orthogonal component of the beat signal, respectively. This makes it possible to determine whether the beat frequency is positive or negative, and determine whether the beat frequency is shorter or longer than the delay τ_{D} of the local light.

An optical frequency response in the present disclosure is expressed by the following expression.

$$\begin{matrix}[ Mathematical Expression 3 ] & \\ \tilde{r} ( v ) = \int r ( {τ}_{R} ) exp [ - j 2 π v ( t ) {τ}_{R} ] d {τ}_{R} & ( 3 )\end{matrix}$$

$${τ}_{R} = \frac{2}{c} ( z - {L}_{D} / 2 ) = \frac{2}{c} {z}_{R}$$

$${z}_{R} = z - \frac{{L}_{D}}{2}$$

Here, the parameters are as follows.

r(τ_{R}): reflection coefficient

L_{D}: the delay fiber length for local light

τ_{R}: the relative delay based on the delay amount applied by the delay fiber for local light

z_{R}: the relative length with respect to the delay fiber length for local light

Therefore, in the present disclosure, the maximum relative delay τ_{R} from which the delay amount τ_{AUX}. can be measured is determined. The measurable delay range is expressed as |τ_{R}|<τ_{AUX}/2, and

the optical frequency response in the range expressed by the expression shown below is measured with respect to the relative distance z_{R}.

[Mathematical formula 4]

|z−L_{D}/2|≤cτ_{AUX}/4 (4)

In this manner, the delay τ_{AUX}. in the reference interferometer 30 determines the length of the measurable relative distance in the present disclosure.

(Role of the Local Light Delay Fiber 40)

In the present disclosure, not only the delay τ^{AUX} but also wavelength dispersion at the time of propagation through the fiber length corresponding to the delay τ_{D} is caused in the local light, and a replica of the backscattered light propagating through the delay τ_{D} is generated. By causing this replica to interfere with the backscattered light in the 90-degree hybrid 21, it is possible to selectively detect a beat signal with the backscattered light from the vicinity of the delay τ_{D} while compensating for the wavelength dispersion.

Also, in the present disclosure, the delay I_{A}ux. in the reference interferometer 30 determines the length of the measurable relative distance. For this reason, the reference interferometer 30 shorter than the laser coherence length can be used even in long-distance measurement in which the measurement target optical fiber 92 exceeds the laser coherence length. Accordingly, the quality of the clock signal does not deteriorate in the present disclosure.

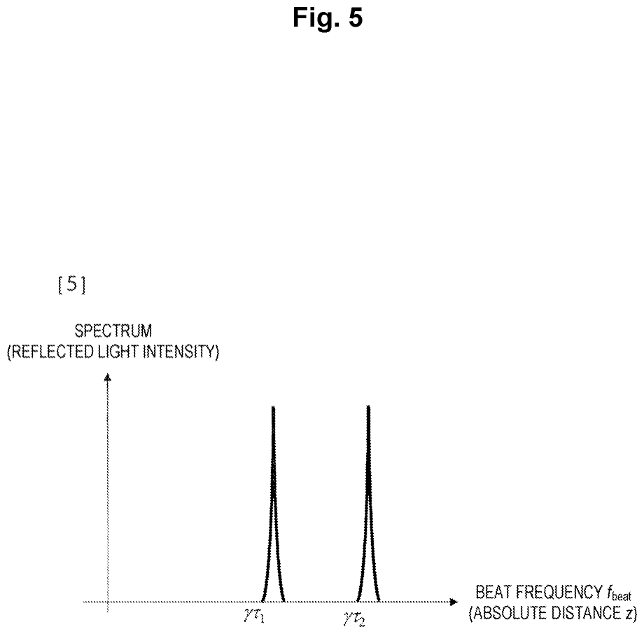

FIG. 5 illustrates an example of a spectrum to be measured with the configuration illustrated in FIG. 2. In the A/D 124, the beat frequency f_{beat} corresponding to the absolute distance z is observed.

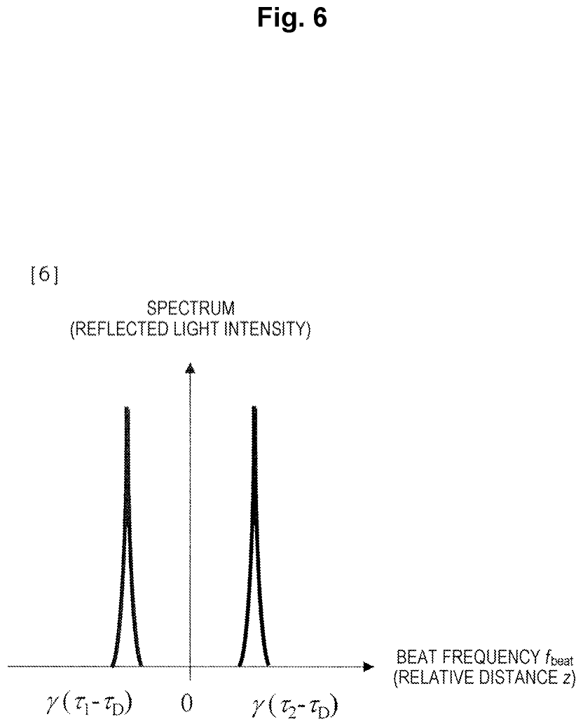

FIG. 6 illustrates an example of a spectrum to be measured with the configuration of the present disclosure. In the present disclosure, the beat frequency f_{beat} corresponding to the relative distance z based on the delay τ_{D} in the local light delay fiber 40 is observed.

(Execution of Long-Distance Ultra-High Spatial Resolution Measurement)

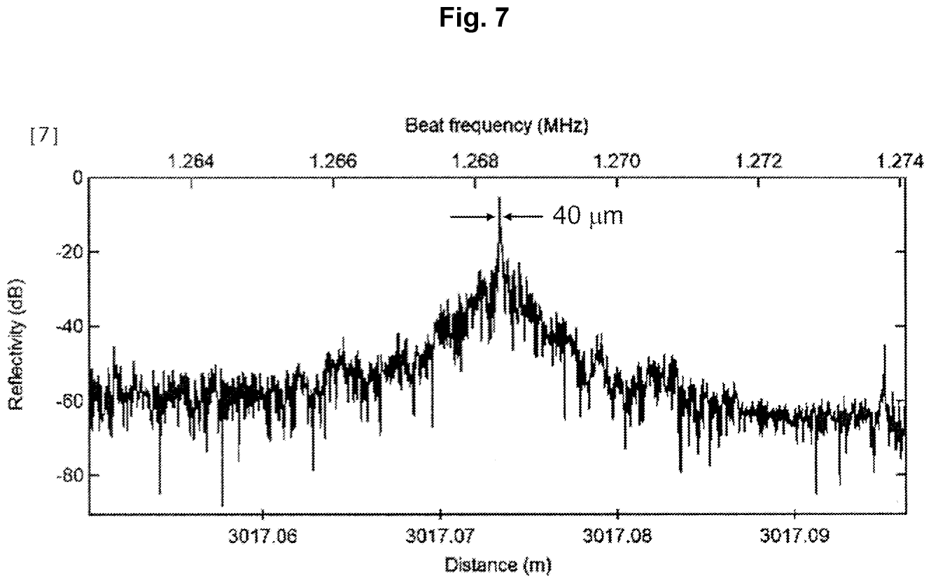

FIG. 7 illustrates an example of results of Fresnel reflection measurement at a point of 3 km. It can be seen that reflection of 40 μm can be detected. As described above, according to the present disclosure, it is possible to measure a long distance exceeding km with a spatial resolution of 100 μm or lower. Thus, soundness of an optical device installed at a long distance can be diagnosed.

(Points of the Present Disclosure)
Backscattered light at a relative distance with respect to the local light delay fiber can be measured.
The delay fiber serves to set the reference distance and wavelength dispersion compensation in relative distance measurement.
By making the local light delay fiber longer, it is possible to measure long-distance backscattered light.

Note that a signal processing device (not shown) included in the optical frequency domain reflectivity measuring apparatus of the present disclosure can also be formed with a computer and a program, and the program can be recorded on a recording medium or be provided through a network.

### INDUSTRIAL APPLICABILITY

The present disclosure can be applied in information and communication industries.

### REFERENCE SIGNS LIST

11 TLS
12, 14, 31, 34 coupler
13 circulator
21 90-degree hybrid
22, 35, 122 BPD
23, 123 LPF
24, 124 A/D
30, 130 auxiliary interferometer
32, 33 transmission path
91 optical frequency domain reflectivity measuring apparatus
92 measurement target optical fiber

1. An optical frequency domain reflectivity measuring apparatus comprising:
a local light delay fiber that delays local light;
an optical 90-degree hybrid that receives an input of the local light delayed by the local light delay fiber and backscattered light from a measurement target, causes the local light and the backscattered light to interfere with each other, and generates an in-phase component and an orthogonal component of a beat signal generated by the interference; and
a balance photodetector that detects the in-phase component and the orthogonal component of the beat signal,
wherein
an optical frequency response of the measurement target is measured with respect to a relative distance based on the local light delay fiber.

2. The optical frequency domain reflectivity measuring apparatus according to claim 1, wherein
a beat frequency is determined to be positive or negative, on a basis of the in-phase component and the orthogonal component of the beat signal.

3. An optical frequency domain reflectivity measuring method implemented by an optical frequency domain reflectivity measuring apparatus, the optical frequency domain reflectivity measuring apparatus including
a local light delay fiber that delays local light,
an optical 90-degree hybrid that receives an input of the local light delayed by the local light delay fiber and backscattered light from a measurement target, and outputs each of an in-phase component and an orthogonal component of a beat signal generated by interference between the local light and the backscattered light, and
a balance photodetector that detects the in-phase component and the orthogonal component of the beat signal,
the optical frequency domain reflectivity measuring method comprising
measuring an optical frequency response of the measurement target with respect to a relative distance based on the local light delay fiber.
